(19) United States
(12) Patent Application Publication
(10) Pub. No.: US 2009/0041324 A1
(43) Pub. Date: Feb. 12, 2009

(54) IMAGE DIAGNOSIS SUPPORT SYSTEM, MEDICAL IMAGE MANAGEMENT APPARATUS, IMAGE DIAGNOSIS SUPPORT PROCESSING APPARATUS AND IMAGE DIAGNOSIS SUPPORT METHOD

(76) Inventors: Hitoshi YAMAGATA, Otawara-shi (JP); Sumiaki Matsumoto, Kobe-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/187,866

(22) Filed: Aug. 7, 2008

(30) Foreign Application Priority Data
Aug. 9, 2007 (JP) 2007-208359

(51) Int. Cl. G06K 9/00

(52) U.S. Cl. 382/131

(57) ABSTRACT

An image diagnosis assistance system which includes a medical image management apparatus and an image diagnosis assistance processing apparatus configured to communicate with each other via a communication network, wherein the medical image management apparatus includes storage unit which stores a medical image obtained by a medical image diagnosis apparatus, extraction unit which extracts, from the medical image, as a diagnosis target image, a partial region including an anatomical region which is the target of image diagnosis, and transmission unit which transmits the diagnosis target image to the image diagnosis assistance processing apparatus via the communication network, and the image diagnosis assistance processing apparatus includes reception unit which receives the diagnosis target image via the communication network, and processing unit which performs image diagnosis assistance processing to assist the image diagnosis concerning the anatomical region with respect to the diagnosis target image.

### CROSS-REFERENCE TO RELATED APPLICATIONS

This application is based upon and claims the benefit of priority from prior Japanese Patent Application No. 2007-208359, filed Aug. 9, 2007, the entire contents of which are incorporated herein by reference.

### BACKGROUND OF THE INVENTION

1. Field of the Invention

The present invention relates to a computer-aided diagnosis which extracts and displays a region which is a lesion candidate from image data collected using the medical image diagnosis modality of an X-ray computed tomography apparatus (an X-ray CT apparatus) or the like. More particularly, it relates to an image diagnosis support system which realizes the provision of a network type image diagnosis support service, a medical image management apparatus, an image diagnosis support processing apparatus, and an image diagnosis support method.

2. Description of the Related Art

At the present day, a lung cancer heads a list of malignant deaths and goes on increasing in Japan. Therefore, a social demand for early detection is strong with respect to the lung cancer like precaution as a countermeasure for smoking. In each municipalities in Japan, a lung cancer examination based on a chest plain radiograph and a sputum cytodiagnosis is carried out. However, a report “Study Group Concerning Cancer Examination Effectiveness Evaluation” issued from Health and Welfare Ministry in Japan in 1998 concludes that a current lung cancer examination has effectiveness but it is small. An X-ray computed tomography (which will be referred to as a CT hereinafter) can readily detect a lung field type lung cancer as compared with a chest plain radiograph, but it was not able to be used for examination since its imaging time is long before 1990 when a helical scanning type CT (helical CT) appeared. However, soon after the helical CT appeared, a method of using a relatively low X-ray tube current to perform imaging for a reduction in radiation exposure (which will be referred to as a low-dose helical CT hereinafter) was developed, and a pilot study of a lung cancer examination using this method was carried out in Japan and the United States. As a result, a fact that the low-dose helical CT has a lung cancer detection rate greatly higher than that of the chest plain radiograph was proved.

On the other hand, a time required for imaging by the helical CT is kept being reduced due to an increase CT detectors after 1998. The latest multi-detector helical CT (MDCT), an entire lung can be imaged in 10 seconds with a substantially isotropic resolution that is less than 1 mm. Such a CT technology innovation develops a potentiality of enabling detection of a lung cancer when it is smaller. However, the MDCT also has a problem of considerably increasing a burden on diagnosing reading since it generates several-hundreds images per scanning operation.

Based on such a background, it is widely recognized that a computer assisted diagnosis (which will be referred to as a CAD hereinafter) using a computer to avoid an oversight of a lung cancer is required for the low-dose helical CT to be established as a lung cancer examination method.

Since a small lung cancer in a lung field appears as a nodular abnormality in a CT image, automatic detection of such an abnormality is an important theme, and various studies have been conducted since the 1990's (see, e.g., “David S. Paik and seven others, “Surface Normal Overlap: A Computer-aided Detection Algorithm with Application to Colonic Polyps and Lung Nodules in Helical CT”, IEEE Transactions on Medical Imaging, Vol. 23, No. 6, June 2004, pp. 661-675”).

In the imaging of a chest part as an inspection target by use of the MDCT, it is general that around 1000 images per case are obtained. For a screening purpose, around 400 images per case are obtained, but the number of the cases exceeds 100 in a day sometimes, and the amount of data concerning the target of the automatic detection processing of nodule candidates is enormously large. Therefore, the performing of the automatic detection processing with an MDCT apparatus is limited. In general, the automatic detection processing of the image data is performed in a computer server [the images are generally utilized in digital imaging and communications in medicine (DICOM) as a data format code for use in a picture archiving and communication system (PACS), and hence the computer server is referred to as a DICOM server. Hereinafter, this will be referred to as the DICOM server] of the PACS in which the image data is to be stored, and the thus detected result is displayed.

The above automatic detection processing in the DICOM server is basically performed in the PACS environment in a facility such as a hospital. Furthermore, an idea that the CAD is operated in the PACS environment where a broad-band network is utilized outside the hospital has already been suggested (e.g., see Jpn. Pat. Appln. KOKAI Publication Nos. 2001-104253 and 2002-329190). It is considered that in the future, a network type image diagnosis support system will be put to practical use so that the CAD operation is performed in the facility or on the broad-band network.

The network type image diagnosis support system heretofore suggested has the following various problems.

(1) A large amount of data has to be transmitted and received between a server and a CAD processing unit, and hence much time is required for the transmission and reception and a large number of network resources are occupied.

(2) In the CAD processing, a large amount of data has to be analyzed, and hence much time is required for the analysis and a very large burden is imposed on hardware which performs the CAD processing.

### BRIEF SUMMARY OF THE INVENTION

Under such situations, it has been demanded that the amount of data to be transmitted for CAD processing via a network be decreased.

Moreover, it has been demanded that the CAD processing be efficiently executable.

According to a first aspect of the present invention, there is provided an image diagnosis assistance system which includes a medical image management apparatus and an image diagnosis assistance processing apparatus configured to communicate with each other via a communication network, wherein the medical image management apparatus includes: storage unit which stores a medical image obtained by a medical image diagnosis apparatus; extraction unit which extracts, from the medical image, as a diagnosis target image, a partial region including an anatomical region which is the target of image diagnosis; and transmission unit which transmits the diagnosis target image to the image diagnosis assistance processing apparatus via the communication network, and the image diagnosis assistance processing apparatus includes: reception unit which receives the diagnosis target image via the communication network; and processing unit which performs image diagnosis assistance processing to assist the image diagnosis concerning the anatomical region with respect to the diagnosis target image.

According to a second aspect of the present invention, there is provided a medical image management apparatus which constitutes an image diagnosis assistance system together with an image diagnosis assistance processing apparatus configured to communicate via a communication network, comprising: a storage unit which stores a medical image obtained by a medical image diagnosis apparatus; an extraction unit which extracts, from the medical image, as a diagnosis target image, a partial region including an anatomical region which is the target of image diagnosis; and a transmission unit which transmits the diagnosis target image to the image diagnosis assistance processing apparatus via the communication network.

According to a third aspect of the present invention, there is provided an image diagnosis assistance method of assisting image diagnosis with a medical image management apparatus and an image diagnosis assistance processing apparatus configured to communicate with each other via a communication network, wherein the medical image management apparatus stores a medical image obtained by a medical image diagnosis apparatus, extracts, from the medical image, as a diagnosis target image, a partial region including an anatomical region which is the target of the image diagnosis, and transmits the diagnosis target image to the image diagnosis assistance processing apparatus via the communication network, and the image diagnosis assistance processing apparatus receives the diagnosis target image via the communication network, and performs image diagnosis assistance processing to assist the image diagnosis concerning the anatomical region with respect to the diagnosis target image.

According to a fourth aspect of the present invention, there is provided an image diagnosis assistance system which includes a medical image management apparatus and an image diagnosis assistance processing apparatus configured to communicate with each other via a communication network, wherein the medical image management apparatus includes: a storage unit which stores a medical image obtained by a medical image diagnosis apparatus; an extraction unit which respectively extracts, from the medical image, as diagnosis target images, a plurality of regions each including an anatomical region which is the target of image diagnosis; and a transmission unit which transmits a plurality of extracted diagnosis target images to the image diagnosis assistance processing apparatus via the communication network, and the image diagnosis assistance processing apparatus includes: a reception unit which receives the plurality of diagnosis target images via the communication network; plurality of processing units which perform image diagnosis assistance processing to assist the image diagnosis concerning the anatomical regions with respect to the diagnosis target images; and an allocation unit which allocates the image diagnosis assistance processing with respect to the plurality of diagnosis target images to the plurality of processing units, respectively.

According to a fifth aspect of the present invention, there is provided an image diagnosis assistance processing apparatus which constitutes an image diagnosis assistance system together with a medical image management apparatus configured to communicate via a communication network, comprising: a reception unit which receives, from the medical image management apparatus via the communication network, a plurality of diagnosis target images respectively extracted as a plurality of regions each including an anatomical region which is the target of image diagnosis from a medical image obtained by a medical image diagnosis apparatus; a plurality of processing units which perform image diagnosis assistance processing to assist the image diagnosis concerning the anatomical regions with respect to the diagnosis target images; and an allocation unit which allocates the image diagnosis assistance processing with respect to the plurality of diagnosis target images to the plurality of processing units.

According to a sixth aspect of the present invention, there is provided an image diagnosis assistance method of assisting image diagnosis with a medical image management apparatus and an image diagnosis assistance processing apparatus configured to communicate with each other via a communication network, wherein the medical image management apparatus stores a medical image obtained by a medical image diagnosis apparatus, respectively extracts, from the medical image, as diagnosis target images, a plurality of regions each including an anatomical region which is the target of the image diagnosis, and transmits a plurality of extracted diagnosis target images to the image diagnosis assistance processing apparatus via the communication network, and the image diagnosis assistance processing apparatus receives the plurality of diagnosis target images via the communication network, and allocates image diagnosis assistance processing with respect to the plurality of diagnosis target images to a plurality of processing units which performs the image diagnosis assistance processing to assist the image diagnosis concerning the anatomical regions with respect to the diagnosis target images, respectively.

According to a seventh aspect of the present invention, there is provided an image diagnosis assistance system which includes a medical image management apparatus and an image diagnosis assistance processing apparatus configured to communicate with each other via a communication network, wherein the medical image management apparatus includes: a storage unit which stores a plurality of medical images obtained by a medical image diagnosis apparatus; an extraction unit which respectively extracts, from the plurality of medical images, as diagnosis target images, a plurality of regions each including an anatomical region which is the target of image diagnosis; and a transmission unit which transmits the plurality of diagnosis target images extracted from the plurality of medical images, respectively, to the image diagnosis assistance processing apparatus via the communication network, and the image diagnosis assistance processing apparatus includes: a reception unit which receives the diagnosis target images via the communication network; a plurality of processing units which perform image diagnosis assistance processing to assist the image diagnosis concerning the anatomical regions with respect to the diagnosis target images; and an allocation unit which allocates the image diagnosis assistance processing with respect to the plurality of diagnosis target images extracted from the plurality of medical images, respectively, to the plurality of processing units, respectively.

According to a eighth aspect of the present invention, there is provided an image diagnosis assistance processing apparatus which constitutes an image diagnosis assistance system together with a medical image management apparatus configured to communicate via a communication network, comprising: a reception unit which receives, from the medical image management apparatus via the communication network, a plurality of diagnosis target images respectively extracted as a plurality of regions each including an anatomical region which is the target of image diagnosis from a plurality of medical images obtained by a medical image diagnosis apparatus; a plurality of processing units which performs image diagnosis assistance processing to assist the image diagnosis concerning the anatomical regions with respect to the diagnosis target images; and an allocation unit which allocates the image diagnosis assistance processing with respect to the plurality of diagnosis target images extracted from the plurality of medical images, respectively, to the plurality of processing units, respectively.

According to a ninth aspect of the present invention, there is provided an image diagnosis assistance method of assisting image diagnosis with a medical image management apparatus and an image diagnosis assistance processing apparatus configured to communicate with each other via a communication network, wherein the medical image management apparatus stores a plurality of medical images obtained by a medical image diagnosis apparatus, respectively extracts, from the plurality of medical images, as diagnosis target images, a plurality of regions each including an anatomical region which is the target of the image diagnosis, and transmits the plurality of diagnosis target images extracted from the plurality of medical images, respectively, to the image diagnosis assistance processing apparatus via the communication network, and the image diagnosis assistance processing apparatus receives the diagnosis target images via the communication network, and allocates image diagnosis assistance processing with respect to the plurality of diagnosis target images extracted from the plurality of medical images, respectively, to a plurality of processing units which performs the image diagnosis assistance processing to assist the image diagnosis concerning the anatomical regions with respect to the diagnosis target images, respectively.

According to a tenth aspect of the present invention, there is provided an image diagnosis assistance system which includes a medical image management apparatus and an image diagnosis assistance processing apparatus configured to communicate with each other via a communication network, wherein the medical image management apparatus includes: a storage unit which stores a medical image obtained by a medical image diagnosis apparatus; and a unit which transmits at least a part of the medical image as a diagnosis target image to the image diagnosis assistance processing apparatus via the communication network, and the image diagnosis assistance processing apparatus includes: a unit which receives the diagnosis target image via the communication network; a processing unit which performs image diagnosis assistance processing to assist image diagnosis concerning an anatomical region with respect to the diagnosis target image; and a transmission unit which transmits, to the medical image management apparatus, result information which indicates the result of the image diagnosis assistance processing without involving the diagnosis target image, and the medical image management apparatus further includes: a unit which receives the result information; and a unit which displays a result image indicating the result of the image diagnosis assistance processing indicated by the received result information together with the medical image stored in the storage unit.

According to a eleventh aspect of the present invention, there is provided a medical image management apparatus which constitutes an image diagnosis assistance system together with an image diagnosis assistance processing apparatus configured to communicate via a communication network, comprising: a storage unit which stores a medical image obtained by a medical image diagnosis apparatus; a unit which transmits at least a part of the medical image as a diagnosis target image to the image diagnosis assistance processing apparatus via the communication network; a unit which receives result information which indicates the result of image diagnosis assistance processing to assist image diagnosis concerning an anatomical region with respect to the diagnosis target image without involving the diagnosis target image; and a generation unit which generates a result image indicating the result of the image diagnosis assistance processing indicated by the received result information together with the medical image stored in the storage unit.

According to a twelfth aspect of the present invention, there is provided an image diagnosis assistance processing apparatus which constitutes an image diagnosis assistance system together with a medical image management apparatus configured to communicate via a communication network, comprising: a unit which receives a diagnosis target image which is at least a part of a medical image obtained by a medical image diagnosis apparatus, via the communication network; a processing unit which performs image diagnosis assistance processing to assist image diagnosis concerning an anatomical region with respect to the diagnosis target image; and a transmission unit which transmits, to the medical image management apparatus, result information which indicates the result of the image diagnosis assistance processing without involving the diagnosis target image.

According to a thirteenth aspect of the present invention, there is provided an image diagnosis assistance method of assisting image diagnosis with a medical image management apparatus and an image diagnosis assistance processing apparatus configured to communicate with each other via a communication network, wherein the medical image management apparatus stores a medical image obtained by a medical image diagnosis apparatus, and transmits at least a part of the medical image as a diagnosis target image to the image diagnosis assistance processing apparatus via the communication network, and the image diagnosis assistance processing apparatus receives the diagnosis target image via the communication network, performs image diagnosis assistance processing to assist image diagnosis concerning an anatomical region with respect to the diagnosis target image, and transmits, to the medical image management apparatus, result information which indicates the result of the image diagnosis assistance processing without involving the diagnosis target image, and the medical image management apparatus further receives the result information, and generates a result image indicating the result of the image diagnosis assistance processing indicated by the received result information together with the medical image stored in the storage unit.

Additional objects and advantages of the invention will be set forth in the description which follows, and in part will be obvious from the description, or may be learned by practice of the invention. The objects and advantages of the invention may be realized and obtained by unit of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing the constitution of an image diagnosis support system (a CAD service system) according to one embodiment of the present invention;

FIG. 2 is a flow chart showing the processing procedure of a workstation provided in a DICOM server in FIG. 1;

FIG. 3 is a diagram showing one example of a region to be extracted as image region data;

FIG. 4 is a flow chart showing the processing procedure of a workstation provided in a CAD server 2 in FIG. 1;

FIG. 5 is a diagram showing a first specific example of scheduling for CAD processing;

FIG. 6 is a diagram showing a second specific example of the scheduling for the CAD processing;

FIG. 7 is a diagram showing a third specific example of the scheduling for the CAD processing;

FIG. 8 is a diagram showing a fourth specific example of the scheduling for the CAD processing;

FIG. 9 is a diagram showing a fifth specific example of the scheduling for the CAD processing;

FIG. 10 is a diagram showing one example of an image indicating left lung data; and

FIG. 11 is a diagram showing one example of mask information generated based on the left lung data shown in FIG. 10.

### DETAILED DESCRIPTION OF THE INVENTION

Hereinafter, one embodiment will be described with reference to the drawings.

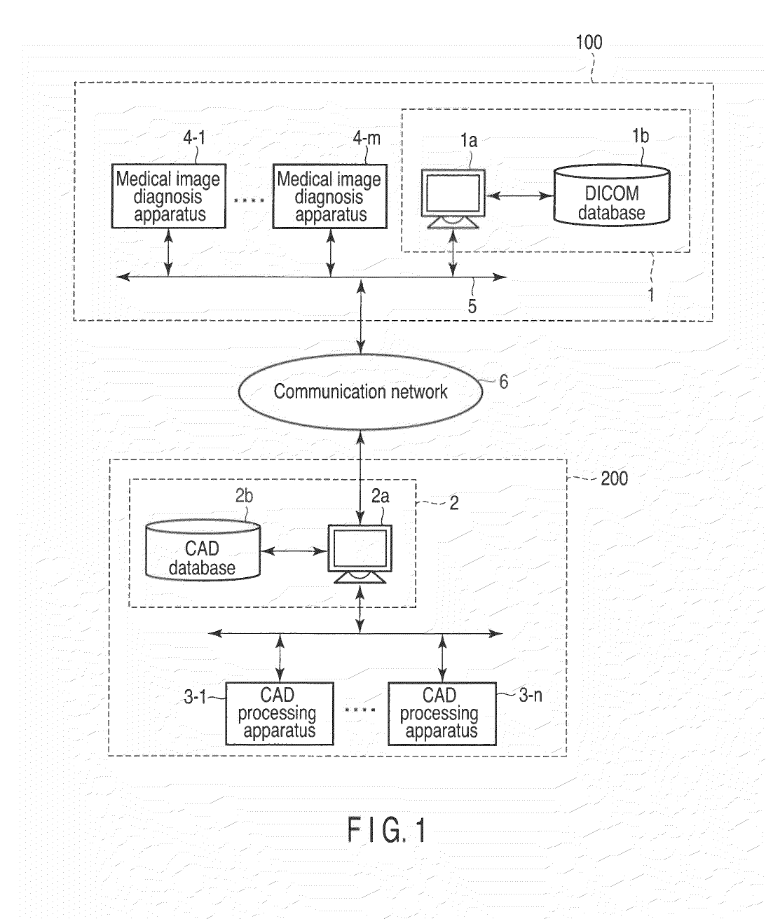

FIG. 1 is a diagram showing the constitution of an image diagnosis support system (hereinafter referred to as the CAD service system) according to the present embodiment.

This CAD service system includes a DICOM server 1 installed in a hospital 100, and a CAD server 2 and a plurality of CAD processing apparatuses 3-1 to 3-n installed in a CAD service center 200.

The DICOM server 1 includes a workstation 1a and a DICOM database 1b. The workstation 1a can communicate with medical image diagnosis apparatuses 4-1 to 4-m via a medical image network 5. The medical image diagnosis apparatuses 4-1 to 4-m constitute, for example, MDCT. The medical image diagnosis apparatuses 4-1 to 4-m image a concerned region including a part of a subject to obtain three-dimensional medical image data. The medical image diagnosis apparatuses 4-1 to 4-m send the medical image data to the DICOM server 1 via the medical image network 5. In the DICOM server 1, the workstation 1a stores the medical image data sent from the medical image diagnosis apparatuses 4-1 to 4-m in the DICOM database 1b to manage the data. It is to be noted that in the DICOM database 1b, the medical image data is managed together with supplementary information which conforms to DICOM.

The workstation 1a can communicate with the CAD server 2 via the medical image network 5 and a communication network 6. It is to be noted that as the communication network 6, an off-hospital broad-band network is typically used. However, as the communication network 6, an in-hospital network, a public communication network and the like can arbitrarily be used. The workstation 1a requests the CAD server 2 to execute CAD processing concerning the medical image data, if necessary.

The CAD server 2 includes a workstation 2a and a CAD database 2b. The workstation 2a allows the CAD processing apparatuses 3-1 to 3-n to execute the CAD processing in accordance with the request from the DICOM server 1. The CAD processing apparatuses 3-1 to 3-n execute the CAD processing under the control of the workstation 2a, and return the result to the CAD server 2. In the CAD server 2, the workstation 2a notifies the DICOM server 1 of the result of the CAD processing. In the DICOM server 1, the workstation 1a stores the result of the CAD processing in the DICOM database 1b to manage the result. It is to be noted that the workstation 2a stores information on the request from the DICOM server 1 and information on the CAD processing result in the CAD database 2b to manage the information.

In the DICOM server 1, the workstation 1a stores the result of the CAD processing notified from the CAD server 2 in the DICOM database 1b to manage the result. The workstation 1a takes the medical image and the CAD processing result from the DICOM database 1b if necessary, and generates an image for browsing the result of the CAD processing to display the image.

Next, the operation of the CAD service system having the above constitution will be described. It is to be noted that there will here be described a case where three-dimensional lung cancer CAD processing is performed so that lung nodules are extracted and observed from a chest part MDCT image.

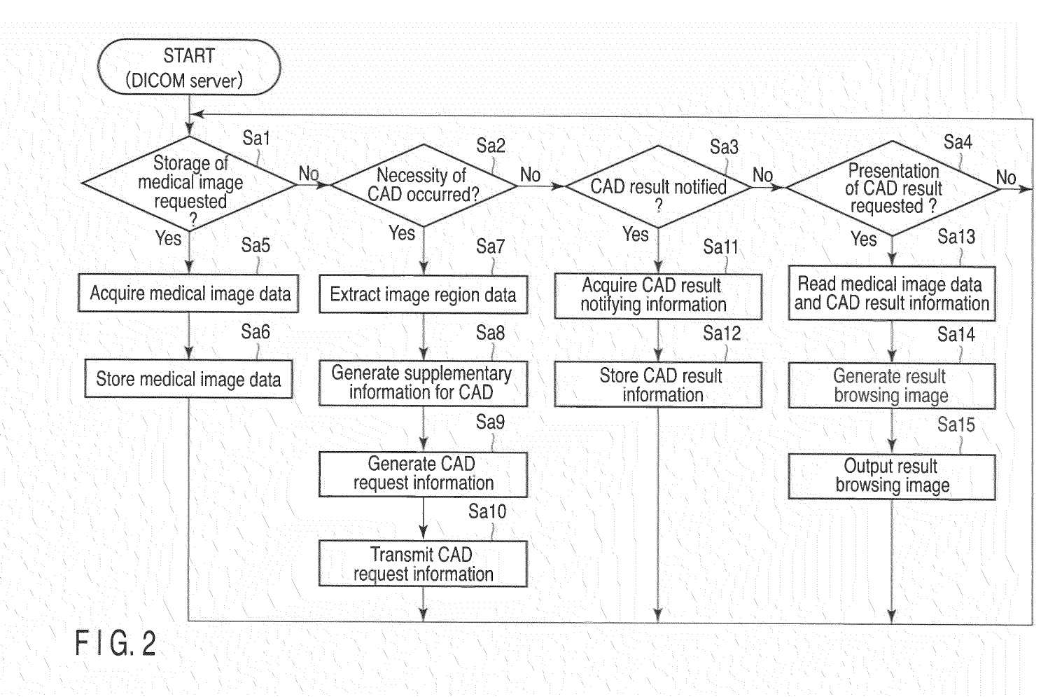

FIG. 2 is a flow chart showing the processing procedure of the workstation 1a.

In steps Sa1 to Sa4, the workstation 1a waits until the storage of the medical image is requested, until the necessity of the CAD processing is occurred, until the result of the CAD processing is notified, or until the presentation of the CAD result is requested.

Furthermore, to observe the lung nodules by use of the CAD service system according to the present embodiment, one of the medical image diagnosis apparatuses 4-1 to 4-m first imaging the MDCT image of a chest part to obtain the medical image data indicating this MDCT image. This medical image data is, for example, multi-slice image data including 800 images in which a region including a lung region and having a length of 40 cm in a body axis direction is reconstituted in a slice thickness of 0.5 mm. In this medical image data, for example, one slice includes 512×512 voxels, and the pixel value of each voxel is represented by two bytes. That is, the medical image data includes the information of 512×512×800=200 Mvoxels, and the amount of the data is 200 M×2=400 Mbytes.

The medical image diagnosis apparatuses 4-1 to 4-m send the acquired medical image data to the DICOM server 1 via the medical image network 5, in a DICOM format to which the supplementary information conforming to the DICOM has been added, to request the storage of the data.

On receiving this request, the workstation 1a advances from the step Sa1 to step S5. In the step Sa5, the workstation 1a acquires the medical image data sent from the medical image diagnosis apparatuses 4-1 to 4-m. Then, in step Sa6, the workstation 1a stores the acquired medical image data in the DICOM database 1b. It is to be noted that the workstation 1a associates the supplementary information with the medical image data to also store the information in the DICOM database 1b. Afterward, the workstation 1a returns to a standby state in the steps Sa1 to Sa4.

Then, at a predetermined timing, the workstation 1a judges that the necessity of the CAD processing is occurred. The predetermined timing may be arbitrary, but is typically a time when a predetermined execution time comes or a time when a user issues an executing instruction. Subsequently, in a case where it is determined that the necessity of the CAD processing has been occurred, the workstation 1a advances from the step Sa2 to step Sa7. In the step Sa7, the workstation 1a selects data as a CAD processing target from the medical image data stored in the DICOM database 1b, and extracts, from the selected medical image data, the data of a region including a lung as image region data. Specifically, the lung region including a chest wall corresponding to the lung is first extracted. This is performed on a right lung and a left lung, respectively. Thus, a right lung region and a left lung region are divided. For this processing, there can be utilized an existing method known by, for example, “Hu S, Hoffman E A, Reinhardt J M. Automatic lung segmentation for accurate quantization of volumetric X-ray CT images. IEEE Trans Med Imaging 2001; 20:490-498”. Then, the workstation 1a extracts, as the image region data, data concerning rectangular parallelepiped regions circumscribed with the right lung region and the left lung region, respectively, from the medical image data.

In a case where a large number of chest part MDCT three-dimensional image data obtained by a screening inspection and the like are stored in the DICOM database 1b, any of these image data is selected as the medical image data which is the CAD processing target, and each image region data is extracted from the plurality of medical image data.

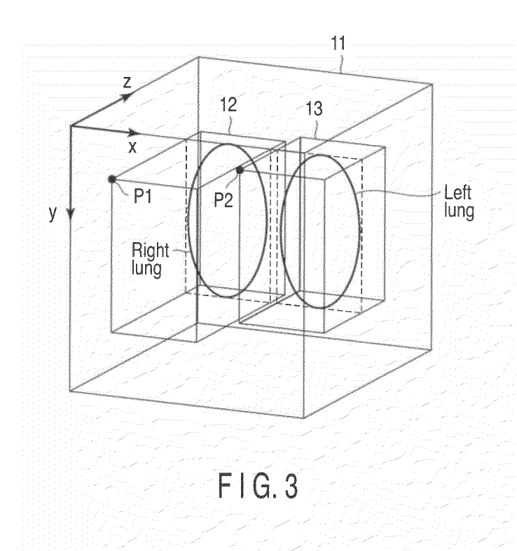

FIG. 3 is a diagram showing one example of a region to be extracted as the image region data.

In FIG. 3, a rectangular solid 11 is the region of a three-dimensional image represented by the medical image data. Moreover, rectangular solids 12, 13 are the regions of the three-dimensional images represented by the image region data, respectively. In addition, the image region data corresponding to the rectangular solid 12 indicates the three-dimensional image including the right lung, and the image region data corresponding to the rectangular solid 13 indicates the three-dimensional image including the left lung. Therefore, in the following description, when the image region data indicating the three-dimensional image including the right lung and the image region data indicating the three-dimensional image including the left lung need to be distinguished, the data will be referred to as the right lung data and the left lung data, respectively.

It is to be noted that as to human lungs, it is generally known that the right lung has a volume larger than that of the left lung. Therefore, even in FIG. 3, the rectangular solid 12 is larger than the rectangular solid 13. That is, the amount of the right lung data is larger than that of the left lung data. Specifically, the rectangular solid 12 includes 200×300×600=34 Mvoxels, and the data amount of the right lung data is 34 M×2=68 Mbytes. On the other hand, the rectangular solid 13 includes 200×300×500=29 Mvoxels, and the data amount of the left lung data is 29 M×2=58 Mbytes. Therefore, the extracted image region data has an amount of about 126 Mbytes, and the amount is about ⅓ of that of the medical image data (400 Mbytes).

In step Sa8, the workstation 1a generates supplementary information required for CAD processing (hereinafter referred to as the CAD supplementary information) with regard to the above extracted image region data. This CAD supplementary information includes, for example, a matrix size (“200×300×600, 200×300×500 in the example of FIG. 3), a voxel size (represented by a length in x, y and z-directions, for example, “0.5 mm, 0.5 mm and 0.3 mm”) and identification information for identifying the image region data and the supplementary information. In the identification information, patient information is not used in consideration of security. Then, the workstation 1a issues the identification information unrelated to the patient information for a purpose of collating, with the image region data, CAD result information transmitted from the CAD server 2 as described later. This identification information is, for example, an arbitrary alphanumeric code, QR (quick response) code or the like.

It is to be noted that the workstation 1a associates, with the medical image data, the CAD supplementary information generated here together with positional information indicating the image position indicated by the image region data in the image indicated by the medical image data, to store the information in a storage device embedded in the workstation 1a or the DICOM database 1b. It is to be noted that the positional information include, for example, the coordinates of points P1, P2 shown in FIG. 3 in an image coordinate system indicated by the medical image data. The positional information may not be stored on the DICOM server 1 side, and may be included in the CAD supplementary information and sent to the CAD server 2.

In step Sa9, the workstation 1a generates CAD request information including the image region data extracted in the step Sa7 and the CAD supplementary information generated in the step Sa8. It is to be noted that the image region data to be included in this CAD request information may be data compressed by a loss-less image compression technique. In JPEG or JPEG2000 of a loss-less mode as a general loss-less image compression technique, a data compression ratio is about ⅓. Therefore, when such compression is performed, the image region data included in the CAD request information has an amount (about 40 Mbytes in the example shown in FIG. 3) of about 1/10 of the original medical image data. When the medical image data concerning a plurality of inspection cases is a CAD processing target, the image region data extracted from the medical image data, and the CAD supplementary information concerning the data are included in the CAD request information. Therefore, the data amount of CAD request information is about 40 M×j bytes, in which j is the number of the inspection cases as the CAD processing targets. It is to be noted that the peripheral region of the lung region is also included in the image indicated by the image region data, but the image of this peripheral region is not necessary for the CAD processing. Therefore, the voxel value of the peripheral region may be replaced with a predetermined pixel value of, for example, −32768 (8000 in the display of hexadecimal numeral 2's complement). In this case, the efficiency of the image compression can be improved, and the data amount can further be decreased.

In step Sa10, the workstation 1a transmits the CAD request information to the CAD server 2 via the medical image network 5 and the communication network 6. Afterward, the workstation 1a returns to the standby state of the steps Sa1 to Sa4.

In the above example, the CAD request information is of about 40 M×j bytes. Therefore, when the medical image network 5 and the communication network 6 have a communication speed of 100 Mbits/second, that is, 12.5 Mbytes/second, time required for the transfer of the CAD request information is about 4×j seconds. This time actually sometimes increases, depending on traffic situation. However, when the above predetermined timing is set to a time zone such as nighttime when the traffic is little, the information can be transferred in the above time.

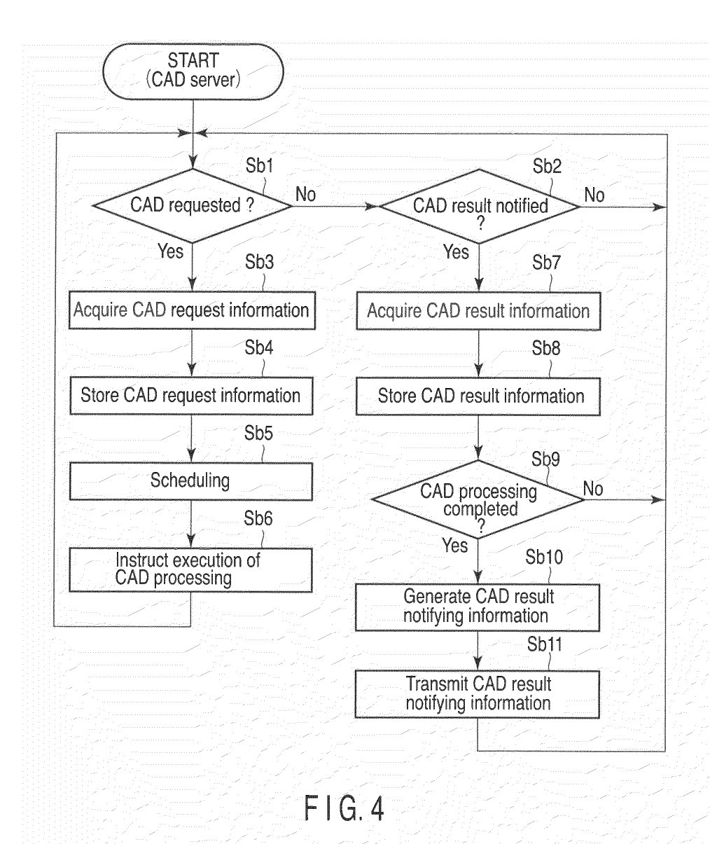

In addition, the workstation 2a of the CAD server 2 performs processing shown in FIG. 4.

In steps Sb1 and Sb2, the workstation 2a is requested by the DICOM server 1 to execute the CAD processing or waits until the result of the CAD processing is notified from the CAD processing apparatuses 3-1 to 3-n.

In a case where the CAD request information transmitted from the workstation 1a as described above reaches the CAD server 2, the workstation 2a judges that the execution of the CAD processing has been requested. At this time, the workstation 2a then advances from the step Sb1 to step Sb3. In the step Sb3, the workstation 2a acquires the CAD request information. In step Sb4, the workstation 2a stores the acquired CAD request information in the CAD database 2b.

In step Sb5, the workstation 2a performs the scheduling of the CAD processing. Specifically, the workstation 2a treats, as one processing unit, the left lung data or the right lung data included in the CAD request information, allocates the CAD processing concerning these processing units to the CAD processing apparatuses 3-1 to 3-n, and performs the scheduling so that the CAD processing apparatuses 3-1 to 3-n perform the CAD processing in parallel. A specific scheduling example will hereinafter be described. It is to be noted that in this specific example, the CAD processing is allocated to two CAD processing apparatuses 3-1, 3 2.

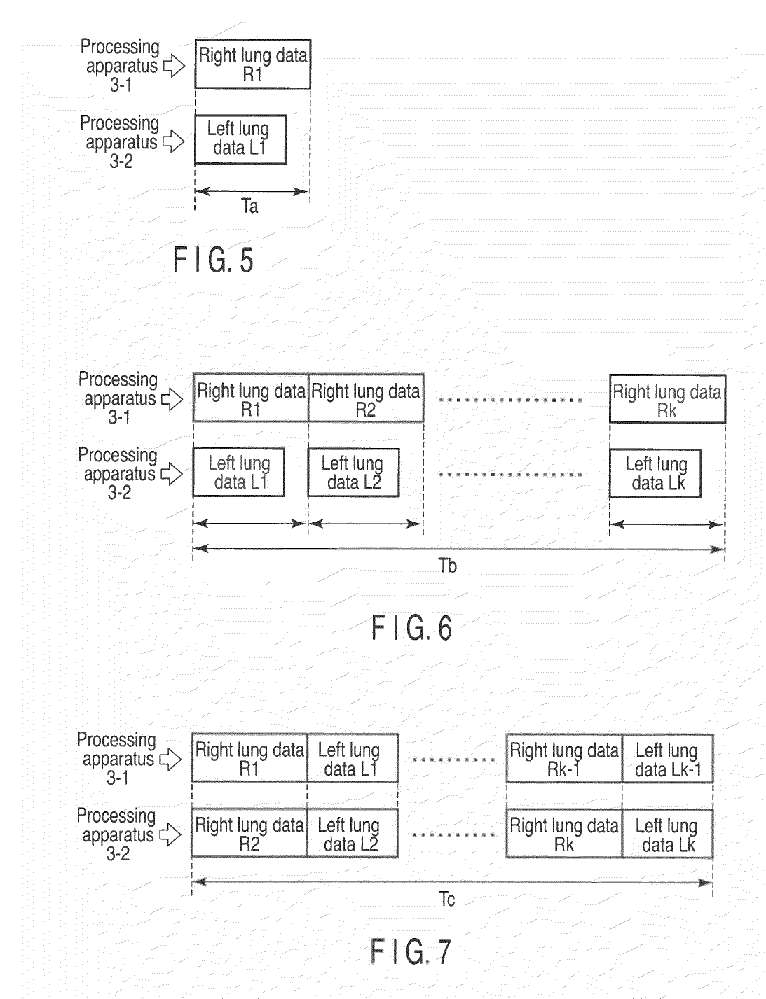

(1) FIG. 5 shows a case where the CAD request information includes only the image region data for one inspection, and right lung data R1 and left lung data L1 of the image region data are allocated to the CAD processing apparatuses 3-1, 3-2, respectively.

In addition, as described above, the right lung data has a data amount larger than that of the left lung data. Therefore, the time required for the CAD processing concerning the right lung data is longer than that concerning the left lung data. Therefore, in FIG. 5, the time (hereinafter referred to as the processing time) required until all the CAD processing concerning the CAD request information is completed is time Ta required for performing the CAD processing as to the right lung data R1. In consequence, the processing time can be shortened as compared with a case where the processing of the right lung data R1 and the left lung data L1 is continuously performed by one CAD processing apparatus.

(2) FIG. 6 shows a case where the CAD request information includes the image region data for k inspections. The data are allocated so that right lung data R1, R2 . . . , Rk of the image region data are processed by the CAD processing apparatus 3-1, left data L1, L2 . . . , Lk are processed by the CAD processing apparatus 3-2, and the CAD processing of the right lung data and left lung data concerning the same inspection is simultaneously started.

In this case, processing time Th is time required for performing the CAD processing of the left data L1, L2 . . . , Lk. In consequence, the processing time can be shortened as compared with a case where the processing of all the image region data is continuously performed by one CAD processing apparatus.

(3) FIG. 7 shows a case where the CAD request information includes the image region data for k inspections. The data are allocated so that the odd-numbered image region data are processed by the CAD processing apparatus 3-1, the even-numbered image region data are processed by the CAD processing apparatus 3-2, and the CAD processing of the left lung data is performed in parallel with that of the right lung data.

In this case, one of the CAD processing apparatuses 3-1, 3-2 hardly has time for waiting until the processing of the other apparatus is completed, so that processing time Tc becomes shorter than the processing time Tb.

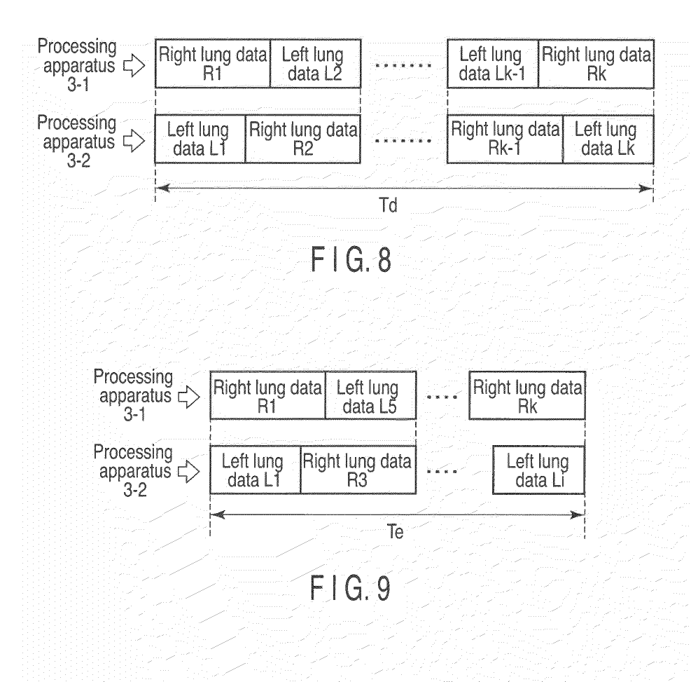

(4) FIG. 8 shows a case where the CAD request information includes the image region data for k inspections. The data are allocated so that the odd-numbered right lung data and the even-numbered left lung data are processed by the CAD processing apparatus 3-1, the odd-numbered left lung data and the even-numbered right lung data are processed by the CAD processing apparatus 3-2, and the CAD processing apparatuses 3-1, 3-2 successively process the data concerning the image region data in an ascending order without taking any waiting time.

In this case, processing time Td is substantially equal to the processing time Tc.

(5) FIG. 9 shows a case where the CAD request information includes the image region data for k inspections. In consideration of the data amounts of the right lung data and the left lung data, the data are allocated regardless of the order of the image region data so as to minimize time from a time when one of the CAD processing apparatuses 3-1, 3-2 completes all the allocated processing to a time when the other apparatus completes the processing.

That is, in FIGS. 6 to 9, it is shown as if the right lung data or the left lung data had a mutually equal data amount, but in actual, the data amount fluctuates owing to individual difference. Therefore, in the scheduling shown in FIGS. 7 and 8, the processing time sometimes lengthens owing to a difference generated in the load of each of the CAD processing apparatuses 3-1, 3-2. However, in FIG. 9, the loads of the CAD processing apparatuses 3-1, 3-2 are equalized, and processing time Te becomes shorter than the processing time Tc, Td.

Additionally, in step Sb6, the workstation 2a instructs the CAD processing apparatuses 3-1 to 3-n to execute the CAD processing of the respective data included in the CAD request information as scheduled in the step Sb5. Afterward, the workstation 2a returns to the standby state of the steps Sb1 and Sb2.

The CAD processing apparatuses 3-1 to 3-n execute the CAD processing in accordance with the above instruction. In three-dimensional lung cancer CAD processing, the CAD processing apparatuses 3-1 to 3-n specify a nodule candidate in a lung field, and judge the position, size, contrast and spherity of the candidate, the histogram of the pixel value in the nodule, a diminution degree in the nodule candidate and the peripheral structure of the candidate, the histogram of the pixel value and the like. The nodule candidate may include a partial structure which has not been regarded as the nodule candidate in the CAD processing process in order to decrease false negative properties as much as possible, especially a structure which has not been regarded as the nodule candidate owing to a small numeric value difference during the judgment. The position of the nodule candidate is judged as, for example, a coordinate in the region of the image indicated by the right lung data and the left lung data. When the CAD supplementary information includes the positional information on the right lung data and the left lung data, the position of the nodule candidate may be judged as the coordinate in the image indicated by the original medical image data based on the information. For this three-dimensional lung cancer CAD processing, for example, a technology for determining the nodule candidate from a plurality of parameters such as the size, contrast, diminution degree and the like of the nodule obtained from the pixel value and foreground part information, that is, the technology of Jpn. Pat. Appln. No. 2006-159423 filed by the present applicant is suitable. Every time the CAD processing apparatuses 3-1 to 3-n end the CAD processing concerning one left or right lung data, the CAD result information indicating the result of the processing is notified to the workstation 2a.

Then, the workstation 2a notified of the CAD result information advances from the step Sb2 to step Sb7. In the step Sb7, the workstation 2a acquires the CAD result information. In step Sb8, the workstation 2a stores the above acquired CAD result information in the CAD database 2b. In step Sb9, the workstation 2a confirms whether or not all the CAD processing concerning the CAD request information has been completed. Then, when the processing has not been completed, the workstation 2a returns to the standby state of the steps Sb1 and Sb2.

When all the CAD result information on all the CAD processing concerning the CAD request information is completely acquired, the workstation 2a advances to the step Sb9 to step Sb10. In the step Sb10, the workstation 2a generates CAD result notifying information including the CAD result information on all the CAD processing concerning the CAD request information. In the workstation 2a, the identification information described in the CAD supplementary information included in the CAD request information is associated with the CAD result information, and included in the CAD result notifying information. It is to be noted that the CAD result notifying information may individually include all of various characteristic amounts indicated in the CAD result information, or may integrally include a part of the plurality of characteristic amounts for each nodule candidate unit. The image region data used in the CAD processing is not included in the CAD result notifying information. The image region data subjected to the CAD processing may be deleted from the CAD database 2b.

In step Sb11, the workstation 2a transmits the CAD result notifying information to the DICOM server 1 via the communication network 6 and the medical image network 5. Afterward, the workstation 2a returns to the standby state of the steps Sb1 and Sb2.

Additionally, in a case where the CAD result notifying information transmitted from the workstation 2a as described above reaches the DICOM server 1, the workstation 1a judges that the CAD result has been notified, and advances from the step Sa3 to step Sa11 in FIG. 2. In the step Sa11, the workstation 1a acquires the CAD result notifying information. In step Sa12, the workstation 1a stores, in the DICOM database 1b, the CAD result information included in the CAD result notifying information. At this time, the workstation 1a collates the identification information associated with the CAD result information and described in the CAD result notifying information with the identification information stored on the DICOM server 1 side to judges the inspection which relates to the CAD result information, whereby the CAD result information is associated with the medical image data. Afterward, the workstation 1a returns to the standby state of the steps Sa1 to Sa4.

In addition, when the presentation of the result of the CAD processing is requested, for example, from a console of the workstation 1a, from the medical image diagnosis apparatuses 4-1 to 4-m or from a computer terminal (not shown) via the medical image network 5, the workstation 1a advances from the step Sa4 to step Sa13. In the step Sa13, the workstation 1a reads, from the DICOM database 1b, the medical image data and CAD result information on the inspection as the target to be provided. In step Sa14, based on the above read medical image data and CAD result information, the workstation 1a generates a result browsing image for a user to browse the result of the CAD processing. Specifically, for example, the section of an MDCT chest part image indicated by the medical image data is displayed by, for example, a multi-planar reformatting (MPR) process, or the nodule candidate indicated by the CAD result information is superimposed and displayed on an image three-dimensionally displayed by a volume rendering (VR) process to generate the result browsing image. Moreover, from the CAD result information for each nodule candidate, the image is processed using nodule candidate judgment parameters (e.g., the degree of a spicular structure or vascular convergence as a nodule peripheral structure, the degree of pleural indentation and the like) different from those for CAD main processing, to generate the result browsing image for secondarily detecting the nodule candidate or performing benignancy/malignancy differential diagnosis or the like in order to minimize false positive and false negative properties. Moreover, the result browsing image may be generated so that various nodule candidate display is performed by a technique suggested in Jpn. Pat. Appln. No. 2006-159423 described above as the display technique for the lung cancer nodule candidate and the peripheral region of the candidate.

In step Sa15, the workstation 1a outputs the result browsing image generated as described above to a requester for the presentation of the CAD processing result. In consequence, a user can advance final radiogram interpretation judgment while confirming the result of the CAD processing. Furthermore, the type of a follow-up inspection and the like may be judged using the technology of Jpn. Pat. Appln. No. 2007-007387 filed by the present applicant as a technique concerning inspection flow assistance for analyzing and processing the automatically detected lung cancer nodule candidate.

As described above, in the present embodiment, the image region data prepared by extracting only a part necessary for the CAD processing from the medical image data obtained by the medical image diagnosis apparatuses 4-1 to 4-m is transferred to the CAD server 2. Therefore, the time required for transferring the data to request the CAD processing can largely be shortened as compared with a case where the medical image data is transferred as it is.

Moreover, in the present embodiment, the plurality of CAD processing apparatuses 3-1 to 3-m share and process the CAD processing. Therefore, the time required for the CAD processing can be shortened, and the individual processing burdens imposed on the CAD processing apparatuses 3-1 to 3-m can be decreased.

Furthermore, in the present embodiment, the identification information irrelevant to the patient information can be used in the CAD supplementary information. Therefore, any patient information is not output from the hospital 100. That is, security concerning the secrecy of the patient information can sufficiently be kept.

Additionally, in the present embodiment, the CAD server 2 transmits, to the DICOM server 1, the CAD result notifying information which does not include any image region data used in the CAD processing and which only indicates various parameters, so that the amount of the data is small. In consequence, the CAD result notifying information can be transferred in a short time. Furthermore, the DICOM server 1 generates the result browsing image indicating the result of the CAD processing on the medical image indicated by the medical image data stored in the DICOM database 1b, so that the user can easily browse the CAD result.

As to this embodiment, the following various modifications can be performed.

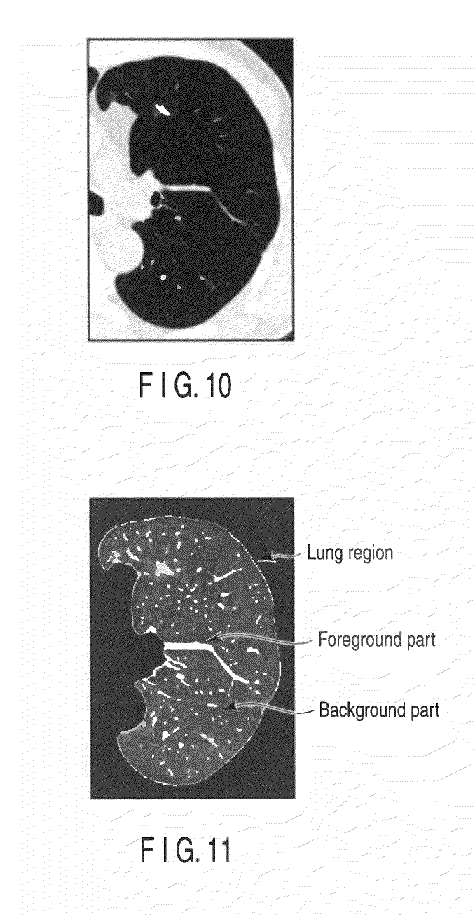

(1) The image processing for the CAD processing may be performed in the DICOM server 1. When, for example, the technique of Jpn. Pat. Appln. No. 2006-159423 is used in the CAD processing, processing is performed to divide the inner part of the divided right and left lung region into two parts including a foreground part approximately corresponding to the lung blood vessel and the nodule and a background part corresponding to another part. Not only in the technique of Jpn. Pat. Appln. No. 2006-159423 but also in many lung cancer CAD processing steps, the segmentation of the foreground part is performed. Then, with respect to so-called preprocessing till the segmentation of the foreground part and main processing for judging various parameters, in general, the main processing requires time about several times to several ten times longer than time required for the preprocessing. Therefore, the preprocessing including the segmentation of the foreground part may be performed by the DICOM server 1 to decrease burdens imposed on the CAD server 2 and the CAD processing apparatuses 3-1 to 3-n. It is to be noted that the existing adaptive threshold processing known by, for example, “Manay S, Yezzi A. Antigeometric diffusion for adaptive thresholding and fast segmentation. IEEE Trans Image Processing 2003; 12:1310 to 1323” may be applied to the processing of dividing the part into two parts including the foreground part and the background part. Then, in a case where the processing of dividing the part into two parts including the foreground part and the background part is performed by the DICOM server 1, for example, mask information for two bits indicating the foreground part and the background part is included in the CAD supplementary information. FIG. 10 is a diagram showing one example of the image indicated by the left lung data, and FIG. 11 is a diagram showing one example of the mask information generated based on the left lung data shown in FIG. 10. It is to be noted that the data amount of the CAD supplementary information in a case where the mask information is included in the CAD supplementary information described in the above embodiment is, for example, about 9 Mbytes in both lung regions.

(2) The processing including the detection of a structure (the nodule candidate) which might be a nodule may be performed by the DICOM server 1 or the workstation 2a. Then, the measurement of the characteristic amount concerning each nodule candidate, or the judgment of whether or not the nodule candidate is the nodule may be shared and performed by the CAD processing apparatuses 3-1 to 3-n. When the nodule candidate is detected by the DICOM server 1, the data in a rectangular parallelepiped region including each nodule candidate is used as the image region data, whereby the data amount of the image data to be transferred from the DICOM server 1 to the CAD server 2 can further be decreased.

(3) One or both of the allocation of the CAD processing for each processing unit to the CAD processing apparatuses 3-1 to 3-n and the scheduling of the CAD processing may be performed by the workstation 1a or another computer installed in the hospital 100. When both the allocation of the CAD processing and the scheduling are performed on a hospital 100 side, the CAD server 2 may be disposed to mediate the processing request from the hospital 100 side to the CAD processing apparatuses 3-1 to 3-n, but may be omitted.

(4) The medical image diagnosis apparatuses 4-1 to 4-m may be magnetic resonant imaging apparatuses, ultrasonic diagnosis apparatuses or the like.

(5) The target of the CAD processing may be a lesion (e.g., cancer of liver) of another anatomical region such as a liver, a brain or a breast.

(6) In the processing of dividing the lung field, in addition to the dividing of the left lung and the right lung, an upper lobe, an intermediate lobe and a lower lobe may be divided in the right lung, and an upper lobe and a lower lobe may be divided in the left lung, respectively. Further multi-dividing may be performed in this manner. In the liver, left and right lobes or anatomically known finer lobes can be divided.

(7) The CAD processing may be shared by three or more CAD processing apparatuses.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image diagnosis assistance system which includes a medical image management apparatus and an image diagnosis assistance processing apparatus configured to communicate with each other via a communication network,
wherein the medical image management apparatus includes:
storage unit which stores a medical image obtained by a medical image diagnosis apparatus;
extraction unit which extracts, from the medical image, as a diagnosis target image, a partial region including an anatomical region which is the target of image diagnosis; and
transmission unit which transmits the diagnosis target image to the image diagnosis assistance processing apparatus via the communication network, and
the image diagnosis assistance processing apparatus includes:
reception unit which receives the diagnosis target image via the communication network; and
processing unit which performs image diagnosis assistance processing to assist the image diagnosis concerning the anatomical region with respect to the diagnosis target image.

2. A medical image management apparatus which constitutes an image diagnosis assistance system together with an image diagnosis assistance processing apparatus configured to communicate via a communication network, comprising:
a storage unit which stores a medical image obtained by a medical image diagnosis apparatus;
an extraction unit which extracts, from the medical image, as a diagnosis target image, a partial region including an anatomical region which is the target of image diagnosis; and
a transmission unit which transmits the diagnosis target image to the image diagnosis assistance processing apparatus via the communication network.

3. The medical image management apparatus according to claim 2, further comprising:
a compression unit which compresses image data indicating the diagnosis target image by a loss-less image compression technique to obtain compressed data,
wherein the transmission unit transmits the compressed data to transmit the diagnosis target image to the image diagnosis assistance processing apparatus.

4. The medical image management apparatus according to claim 2, further comprising:
a generation unit which generates supplementary information with respect to the diagnosis target image such that the supplementary information does not include information specifying a patient corresponding to the medical image from which the diagnosis target image has been extracted,
wherein the transmission unit transmits the supplementary information together with the diagnosis target image.

5. The medical image management apparatus according to claim 2, wherein the extraction unit respectively extracts, from the medical image, as diagnosis target images, a plurality of regions each including the anatomical region which is the target of the image diagnosis.

6. The medical image management apparatus according to claim 2, wherein the extraction unit extracts, from the medical image, as the diagnosis target image, a rectangular parallelepiped region including an organ which is the target of the image diagnosis.

7. An image diagnosis assistance method of assisting image diagnosis with a medical image management apparatus and an image diagnosis assistance processing apparatus configured to communicate with each other via a communication network,
wherein the medical image management apparatus
stores a medical image obtained by a medical image diagnosis apparatus,
extracts, from the medical image, as a diagnosis target image, a partial region including an anatomical region which is the target of the image diagnosis, and
transmits the diagnosis target image to the image diagnosis assistance processing apparatus via the communication network, and
the image diagnosis assistance processing apparatus receives the diagnosis target image via the communication network, and
performs image diagnosis assistance processing to assist the image diagnosis concerning the anatomical region with respect to the diagnosis target image.

8. An image diagnosis assistance system which includes a medical image management apparatus and an image diagnosis assistance processing apparatus configured to communicate with each other via a communication network,
wherein the medical image management apparatus includes:
a storage unit which stores a medical image obtained by a medical image diagnosis apparatus;
an extraction unit which respectively extracts, from the medical image, as diagnosis target images, a plurality of regions each including an anatomical region which is the target of image diagnosis; and
a transmission unit which transmits a plurality of extracted diagnosis target images to the image diagnosis assistance processing apparatus via the communication network, and
the image diagnosis assistance processing apparatus includes:
a reception unit which receives the plurality of diagnosis target images via the communication network;
a plurality of processing units which perform image diagnosis assistance processing to assist the image diagnosis concerning the anatomical regions with respect to the diagnosis target images; and
an allocation unit which allocates the image diagnosis assistance processing with respect to the plurality of diagnosis target images to the plurality of processing units, respectively.

9. An image diagnosis assistance processing apparatus which constitutes an image diagnosis assistance system together with a medical image management apparatus configured to communicate via a communication network, comprising:
a reception unit which receives, from the medical image management apparatus via the communication network, a plurality of diagnosis target images respectively extracted as a plurality of regions each including an anatomical region which is the target of image diagnosis from a medical image obtained by a medical image diagnosis apparatus;
a plurality of processing units which perform image diagnosis assistance processing to assist the image diagnosis concerning the anatomical regions with respect to the diagnosis target images; and
an allocation unit which allocates the image diagnosis assistance processing with respect to the plurality of diagnosis target images to the plurality of processing units.

10. The image diagnosis assistance processing apparatus according to claim 9, wherein the allocation unit further performs scheduling so that the plurality of processing units execute the image diagnosis assistance processing in parallel with one another.

11. An image diagnosis assistance method of assisting image diagnosis with a medical image management apparatus and an image diagnosis assistance processing apparatus configured to communicate with each other via a communication network,
wherein the medical image management apparatus
stores a medical image obtained by a medical image diagnosis apparatus,
respectively extracts, from the medical image, as diagnosis target images, a plurality of regions each including an anatomical region which is the target of the image diagnosis, and
transmits a plurality of extracted diagnosis target images to the image diagnosis assistance processing apparatus via the communication network, and
the image diagnosis assistance processing apparatus receives the plurality of diagnosis target images via the communication network, and
allocates image diagnosis assistance processing with respect to the plurality of diagnosis target images to a plurality of processing units which performs the image diagnosis assistance processing to assist the image diagnosis concerning the anatomical regions with respect to the diagnosis target images, respectively.

12. An image diagnosis assistance system which includes a medical image management apparatus and an image diagnosis assistance processing apparatus configured to communicate with each other via a communication network,
wherein the medical image management apparatus includes:
a storage unit which stores a plurality of medical images obtained by a medical image diagnosis apparatus;
an extraction unit which respectively extracts, from the plurality of medical images, as diagnosis target images, a plurality of regions each including an anatomical region which is the target of image diagnosis; and
a transmission unit which transmits the plurality of diagnosis target images extracted from the plurality of medical images, respectively, to the image diagnosis assistance processing apparatus via the communication network, and
the image diagnosis assistance processing apparatus includes:
a reception unit which receives the diagnosis target images via the communication network;
a plurality of processing units which perform image diagnosis assistance processing to assist the image diagnosis concerning the anatomical regions with respect to the diagnosis target images; and
an allocation unit which allocates the image diagnosis assistance processing with respect to the plurality of diagnosis target images extracted from the plurality of medical images, respectively, to the plurality of processing units, respectively.

13. An image diagnosis assistance processing apparatus which constitutes an image diagnosis assistance system together with a medical image management apparatus configured to communicate via a communication network, comprising:
a reception unit which receives, from the medical image management apparatus via the communication network, a plurality of diagnosis target images respectively extracted as a plurality of regions each including an anatomical region which is the target of image diagnosis from a plurality of medical images obtained by a medical image diagnosis apparatus;
a plurality of processing units which performs image diagnosis assistance processing to assist the image diagnosis concerning the anatomical regions with respect to the diagnosis target images; and
an allocation unit which allocates the image diagnosis assistance processing with respect to the plurality of diagnosis target images extracted from the plurality of medical images, respectively, to the plurality of processing units, respectively.

14. The image diagnosis assistance processing apparatus according to claim 13, wherein the allocation unit further performs scheduling so that the plurality of processing units execute the image diagnosis assistance processing in parallel with one another.

15. An image diagnosis assistance method of assisting image diagnosis with a medical image management apparatus and an image diagnosis assistance processing apparatus configured to communicate with each other via a communication network,
wherein the medical image management apparatus
stores a plurality of medical images obtained by a medical image diagnosis apparatus,
respectively extracts, from the plurality of medical images, as diagnosis target images, a plurality of regions each including an anatomical region which is the target of the image diagnosis, and
transmits the plurality of diagnosis target images extracted from the plurality of medical images, respectively, to the image diagnosis assistance processing apparatus via the communication network, and
the image diagnosis assistance processing apparatus receives the diagnosis target images via the communication network, and
allocates image diagnosis assistance processing with respect to the plurality of diagnosis target images extracted from the plurality of medical images, respectively, to a plurality of processing units which performs the image diagnosis assistance processing to assist the image diagnosis concerning the anatomical regions with respect to the diagnosis target images, respectively.

16. An image diagnosis assistance system which includes a medical image management apparatus and an image diagnosis assistance processing apparatus configured to communicate with each other via a communication network,
wherein the medical image management apparatus includes:
a storage unit which stores a medical image obtained by a medical image diagnosis apparatus; and
a unit which transmits at least a part of the medical image as a diagnosis target image to the image diagnosis assistance processing apparatus via the communication network, and
the image diagnosis assistance processing apparatus includes:
a unit which receives the diagnosis target image via the communication network;
a processing unit which performs image diagnosis assistance processing to assist image diagnosis concerning an anatomical region with respect to the diagnosis target image; and
a transmission unit which transmits, to the medical image management apparatus, result information which indicates the result of the image diagnosis assistance processing without involving the diagnosis target image, and
the medical image management apparatus further includes:
a unit which receives the result information; and
a unit which displays a result image indicating the result of the image diagnosis assistance processing indicated by the received result information together with the medical image stored in the storage unit.

17. A medical image management apparatus which constitutes an image diagnosis assistance system together with an image diagnosis assistance processing apparatus configured to communicate via a communication network, comprising:
a storage unit which stores a medical image obtained by a medical image diagnosis apparatus;
a unit which transmits at least a part of the medical image as a diagnosis target image to the image diagnosis assistance processing apparatus via the communication network;
a unit which receives result information which indicates the result of image diagnosis assistance processing to assist image diagnosis concerning an anatomical region with respect to the diagnosis target image without involving the diagnosis target image; and
a generation unit which generates a result image indicating the result of the image diagnosis assistance processing indicated by the received result information together with the medical image stored in the storage unit.

18. An image diagnosis assistance processing apparatus which constitutes an image diagnosis assistance system together with a medical image management apparatus configured to communicate via a communication network, comprising:
a unit which receives a diagnosis target image which is at least a part of a medical image obtained by a medical image diagnosis apparatus, via the communication network;
a processing unit which performs image diagnosis assistance processing to assist image diagnosis concerning an anatomical region with respect to the diagnosis target image; and
a transmission unit which transmits, to the medical image management apparatus, result information which indicates the result of the image diagnosis assistance processing without involving the diagnosis target image.

19. An image diagnosis assistance method of assisting image diagnosis with a medical image management apparatus and an image diagnosis assistance processing apparatus configured to communicate with each other via a communication network,
wherein the medical image management apparatus stores a medical image obtained by a medical image diagnosis apparatus, and
transmits at least a part of the medical image as a diagnosis target image to the image diagnosis assistance processing apparatus via the communication network, and
the image diagnosis assistance processing apparatus receives the diagnosis target image via the communication network,
performs image diagnosis assistance processing to assist image diagnosis concerning an anatomical region with respect to the diagnosis target image, and
transmits, to the medical image management apparatus, result information which indicates the result of the image diagnosis assistance processing without involving the diagnosis target image, and
the medical image management apparatus further receives the result information, and
generates a result image indicating the result of the image diagnosis assistance processing indicated by the received result information together with the medical image stored in the storage unit.
